(19) United States
(12) Patent Application Publication
(10) Pub. No.: US 2024/0302994 A1
(43) Pub. Date: Sep. 12, 2024

(54) MEMORY SYSTEM

(71) Applicant: Kioxia Corporation, Tokyo (JP)

(72) Inventors: Kenji SAKAUE, Yokohama Kanagawa (JP); Yasuhiko KUROSAWA, Fujisawa Kanagawa (JP)

(21) Appl. No.: 18/589,277

(22) Filed: Feb. 27, 2024

(30) Foreign Application Priority Data
Mar. 10, 2023 (JP) 2023-037870

(51) Int. Cl. G06F 3/06

(52) U.S. Cl. CPC G06F 3/0656; G06F 3/0611; G06F 3/0659; G06F 3/0679

(57) ABSTRACT

A memory system includes a nonvolatile memory, a memory controller, and a control circuit including a buffer and configured to store a first address transmitted by the memory controller in the buffer, generate a second address based on the first address stored in the buffer, and transmit the generated second address to the nonvolatile memory.

### CROSS-REFERENCE TO RELATED APPLICATION(S)

This application is based upon and claims the benefit of priority from Japanese Patent Application No. 2023-037870, filed Mar. 10, 2023, the entire contents of which are incorporated herein by reference.

### FIELD

Embodiments described herein relate generally to a memory system.

### BACKGROUND

Memory systems in which nonvolatile memories such as NAND flash memories are used are known as semiconductor storage devices. Such a memory system includes a nonvolatile memory and a memory controller controlling the nonvolatile memory. In addition to data to be written in the nonvolatile memory, a command, an address, and a control signal are transferred between the memory controller and the nonvolatile memory. There is a problem that an overhead in a transfer sequence, in particular, an overhead of an address cycle, increases as the capacity of the memory system increases.

### DESCRIPTION OF THE DRAWINGS

FIG. 1 is a block diagram illustrating a configuration example of an information processing system including a memory system according to a first embodiment.

FIG. 2 is a diagram illustrating an equivalent circuit of a block in a memory cell array in a nonvolatile memory of the first embodiment.

FIG. 3 is a block diagram illustrating an example of a specific configuration of the nonvolatile memory of the first embodiment.

FIG. 4 is a block diagram illustrating an example of a specific configuration of an address control circuit of the first embodiment.

FIG. 5 is a sequence diagram illustrating an operation sequence under the control of a memory controller of the first embodiment.

FIG. 6 is a sequence diagram illustrating an operation sequence under the control of the memory controller of the first embodiment.

FIG. 7 is a sequence diagram illustrating an operation sequence under the control of the memory controller of the first embodiment.

FIG. 8 is a sequence diagram illustrating an operation sequence under the control of the memory controller of the first embodiment.

FIG. 9 is a timing chart illustrating a setup sequence in the first embodiment.

FIG. 10 is a timing chart illustrating a read sequence in the first embodiment.

FIG. 11 is a timing chart illustrating a write sequence in the first embodiment.

FIG. 12 is a timing chart illustrating an erase sequence in the first embodiment.

FIG. 13 is a block diagram illustrating an example of an address control circuit of a modification of the first embodiment.

FIG. 14 is a sequence diagram illustrating an operation in the modification of the first embodiment.

FIG. 15 is a timing chart illustrating acceleration by batched output addresses in the first embodiment.

FIG. 16 is a block diagram illustrating an example of a specific configuration of a command/address control circuit of a second embodiment.

FIG. 17 is a timing chart illustrating a write sequence in the second embodiment.

FIG. 18 is a sequence diagram illustrating a setup sequence in a multi-plane configuration in the second embodiment.

FIG. 19 is a sequence diagram illustrating a read sequence in the second embodiment.

FIG. 20 is a timing chart illustrating a setup-and-read continuous execution sequence in a comparative example.

FIG. 21 is a timing chart illustrating a setup-and-read continuous execution sequence in the second embodiment.

FIG. 22 is a block diagram illustrating an example of a command control circuit of a third embodiment.

### DETAILED DESCRIPTION

Embodiments provide a memory system capable of reducing an overhead of a transfer sequence.

In general, according to one embodiment, a memory system includes a nonvolatile memory, a memory controller, and a control circuit including a buffer and configured to store a first address transmitted by the memory controller in the buffer, generate a second address based on the first address stored in the buffer, and transmit the generated second address to the nonvolatile memory.

Hereinafter, embodiments will be described in detail with reference to the drawings.

### First Embodiment

According to an embodiment, an address control circuit generating an address based on an input address is provided in a nonvolatile memory. The nonvolatile memory uses the address generated by the address control circuit instead of the input address which is input from a memory controller, for example, during sequential access. Accordingly, it is possible to reduce an overhead in a transfer sequence.

### Configuration of Memory System

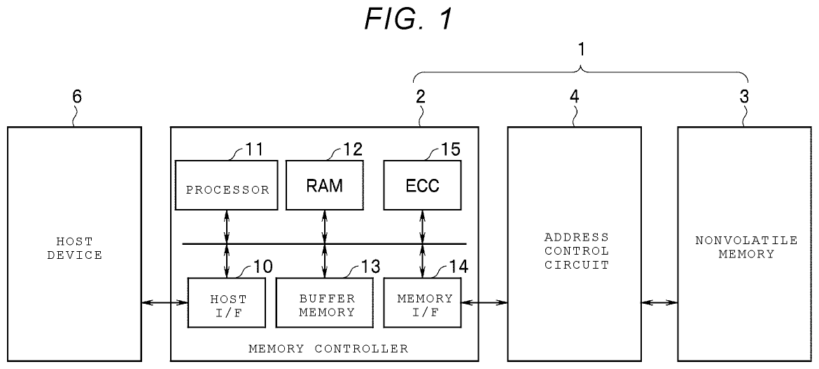

FIG. 1 is a block diagram illustrating a configuration example of an information processing system including a memory system according to the embodiment.

In the information processing system in FIG. 1, a memory system 1 (specifically, a memory controller 2) is connected to a host device 6 via a predetermined interface. The interface conforms to an interface standard such as, for example, an embedded multi-media card (eMMC), which is an example of a parallel interface, or a peripheral component interconnect express (PCIe®) or an M-PHY, which are examples of a serial interface. The host device 6 is, for example, an electronic device such as a personal computer or a portable terminal. In the memory controller 2 and the host device 6, an interface circuit conforming to such an interface standard is implemented. The memory system 1 may be mounted on a main board on which the host device 6 is mounted.

The memory system 1 includes the memory controller 2, a nonvolatile memory 3, and an address control circuit 4. The memory system 1 may be configured with a plurality of semiconductor chips. The address control circuit 4 is more generally referred to as a control circuit.

The address control circuit 4 and the nonvolatile memory 3 may be included in one package. The memory system 1 may be configured as a memory card such as an SD card, a universal flash storage (UFS) device or an embedded multi-media card (eMMC), in which the memory controller 2 and the nonvolatile memory 3 are configured as one package, and a solid-state drive (SSD).

The nonvolatile memory 3 may include a plurality of memory chips. The nonvolatile memory 3 is, for example, a NAND flash memory that includes a plurality of memory cells. The nonvolatile memory 3 includes a memory cell array that includes a plurality of memory cell transistors. Each memory cell transistor configures an electrically rewritable memory cell.

The memory controller 2 may be configured as a large scale integrated circuit (LSI) or a system-on-a-chip (SoC). Functions of each unit of the memory controller 2 may be implemented with dedicated hardware, a processor executing a program, or a combination thereof.

The memory controller 2 is electrically connected to the nonvolatile memory 3 via an input/output (IO) bus such as a NAND bus. The memory controller 2 controls a process of writing data into the nonvolatile memory 3 in response to a write request from the host device 6. The memory controller 2 controls a process of reading data from the nonvolatile memory 3 in response to a read request from the host device 6.

The memory controller 2 includes a host interface circuit (hereinafter referred to as a host I/F) 10, a processor 11, a RAM 12, a buffer memory 13, a memory interface circuit (hereinafter referred to as a memory I/F) 14, and an error-check-and-correction (ECC) circuit 15.

The processor 11 generally controls each unit of the memory system 1 by executing a program stored in a ROM (not illustrated). The processor 11 is configured with a central processing unit (CPU) or the like. The RAM 12 is a working memory for the processor 11. The RAM 12 also stores a lookup table in which logical addresses of data received from the host device 6 and physical addresses indicating each storage region on the nonvolatile memory 3 storing the data have one-to-one correspondence.

The host I/F 10 transmits and receives data to and from the host device 6. The buffer memory 13 temporarily stores data which is to be transmitted to and which has been received from the host device 6. The buffer memory 13 is, for example, a general-purpose memory such as a static random access memory (SRAM) or a dynamic random access memory (DRAM).

When a request from the host device 6 via the host I/F 10 is received, the processor 11 executes various types of control by executing a process in response to the request. For example, the processor 11 controls the process of writing data into the nonvolatile memory 3 in response to a request from the host device 6. The processor 11 controls the process of reading data from the nonvolatile memory 3 in response to a request from the host device 6.

The processor 11 issues a command in response to a request from the host device 6 and also designates an address of the nonvolatile memory 3 which is a processing target of the command. For example, the processor 11 converts a logical address designed by the host device 6 to a physical address by referring to the lookup table.

When a request for writing data is received from the host device 6, the processor 11 determines a physical address in the nonvolatile memory 3 where the data received from the host device 6 is to be stored. That is, the processor 11 manages a write destination for the data. The processor 11 writes data into a storage region (memory region) of the determined physical address. The processor 11 updates the lookup table stored in the RAM 12 and associates the physical address with a logical address designated by the write request.

When a request for reading data is received from the host device 6, the processor 11 searches for a logical address designated by the read request in the lookup table stored in the RAM 12. The processor 11 determines a physical address associated with the logical address. Then, the processor 11 reads data from a storage region of the physical address.

The memory I/F 14 transmits and receives a command, an address, and data to and from the nonvolatile memory 3 via the address control circuit 4. The memory I/F 14 is electrically connected to the address control circuit 4 via an IO bus. The IO bus includes a plurality of signal lines through which signals DQ<7:0>, a pair of data strobe signals DQS and DQSn, and external control signals are transmitted and received. A command, an address, and data transmitted and received by the memory I/F 14 are transferred using the signals DQ<7:0>, as will be described below. The memory I/F 14 transmits and receives the pair of data strobe signals DQS and DQSn. The memory I/F 14 transmits a chip enable signal CEn, a command latch enable signal CLE, an address latch enable signal ALE, a write enable signal WEn, a pair of read enable signals RE and REn, and a write-protect signal WPn, and receives a ready/busy signal R/B, as the external control signals. The letter “n” added to a signal name represents that the corresponding signal is a low-active signal.

The ECC circuit 15 generates an error correction code for write data during the process of writing data, adds the error correction code to the write data, and transmits the write data to the memory I/F 14. The ECC circuit 15 executes error detection and/or error correction on read data using the error correction code provided in the read data during the process of reading data. The ECC circuit 15 may be provided in the memory I/F 14.

### Block Configuration of Memory Cell Array

The nonvolatile memory 3 includes a memory cell array that stores data. The memory cell array includes a plurality of blocks. Each of the plurality of blocks includes a plurality of memory cell transistors (memory cells). In the memory cell array, a plurality of bit lines, a plurality of word lines, a source line, and the like control voltages to be applied to the memory cell transistors.

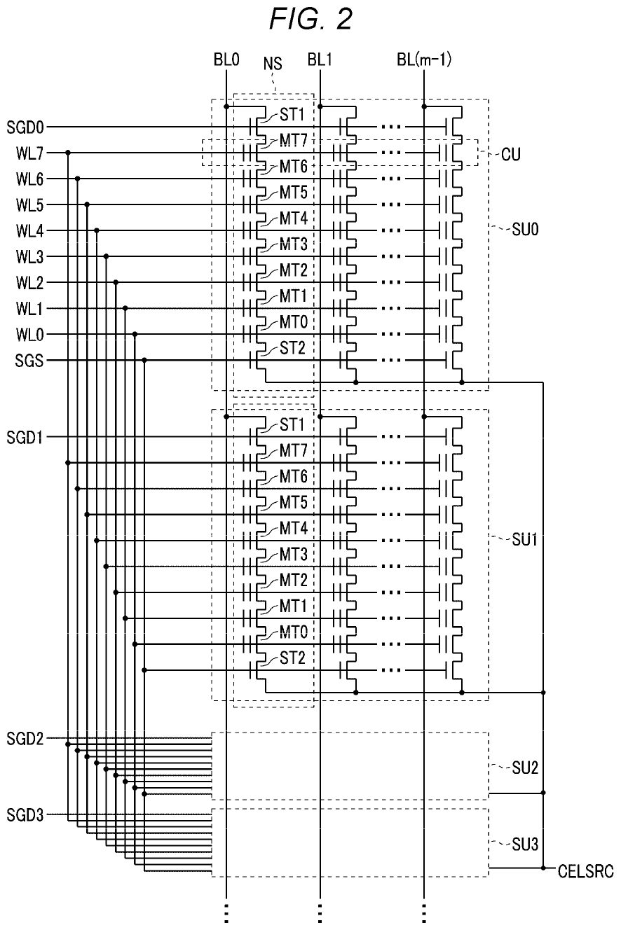

FIG. 2 is a diagram illustrating an equivalent circuit of a block in a memory cell array in the nonvolatile memory 3 according to the embodiment. In FIG. 2, one block is illustrated among the plurality of blocks provided in the memory cell array. The other blocks in the memory cell array have similar configurations as the configuration of FIG. 2.

As illustrated, the block includes, for example, four string units SU0 to SU3 (hereinafter referred to as a string unit SU as a representative of the string units). Each string unit SU includes a plurality of NAND strings NS that each include a plurality of memory cell transistors MT (MT0 to MT7) and select gate transistors ST1 and ST2. The number of memory cell transistors MT provided in the NAND string NS is not limited to eight. The structure of the select gate transistors ST1 and ST2 may be similar to the structure of the memory cell transistor MT. A plurality of select gate transistors may be used in place of the select gate transistors ST1 and ST2. Dummy cell transistors may be provided between the memory cell transistors MT and the select gate transistors ST1 and ST2.

The memory cell transistors MT are connected in series between the select gate transistors ST1 and ST2. A memory cell transistor MT7 at one end (bit line side) is connected to the select gate transistor ST1, and a memory cell transistor MT0 at the other end (source line side) is connected to the select gate transistor ST2.

The gate of the select gate transistor ST1 of each of the string units SU0 to SU3 is connected to select gate lines SGD0 to SGD3 (hereinafter referred to as a select gate line SGD as a representative of the select gate lines). That is, the select gate lines SGD are dedicated for each of the string units SU0 to SU3 even in the same block. The gate of the select gate transistor ST2 of each of the string units SU0 to SU3 is commonly connected to a select gate line SGS.

The gates of the memory cell transistors MT0 to MT7 in the same block are commonly connected to each of word lines WL0 to WL7. That is, the word lines WL0 to WL7 are commonly connected across the plurality of string units SU0 to SU3 in the same block. That is, the gate of a memory cell transistor MTi in the same row in the block is connected to the same word line WLi.

Each NAND string NS is connected to a corresponding bit line. Accordingly, each memory cell transistor MT is connected to a bit line via the select gate transistors ST1 and ST2 or the other memory cell transistors MT provided in the NAND string NS. In general, data of the memory cell transistors MT in the same block is erased collectively as a unit. Meanwhile, a read operation and a write operation for data are typically executed on a plurality of memory cell transistors MT commonly connected to one word line WL disposed in one string unit SU as a unit. A set of memory cell transistors MT sharing the word line WL in one string unit SU is referred to as a cell unit CU.

A write operation and a read operation for the cell unit CU are executed in units of pages. For example, when each cell is a triple level cell (TLC) capable of storing 3-bit (8 values) data, one cell unit CU can store data of three pages. The 3-bit data that can be stored in each memory cell transistor MT corresponds to the data of three pages.

### Configuration of Nonvolatile Memory

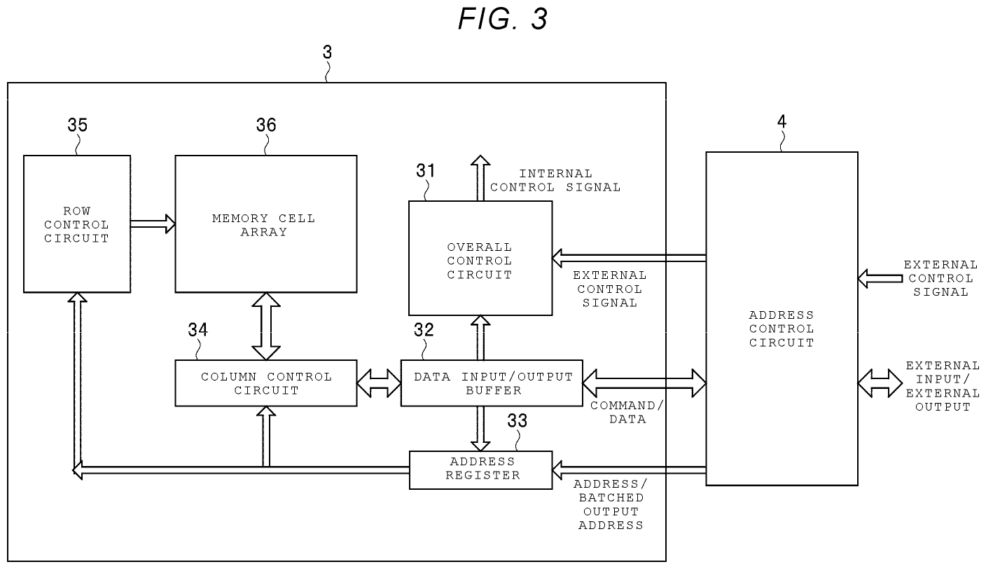

FIG. 3 is a block diagram illustrating an example of a specific configuration of the nonvolatile memory 3 according to the first embodiment.

The nonvolatile memory 3 includes an overall control circuit 31, a data input/output buffer 32, an address register 33, a column control circuit 34, a row control circuit 35, and a memory cell array 36. The memory cell array 36 includes a plurality of blocks described above with reference to FIG. 2. The nonvolatile memory 3 transmits and receives signals to and from the memory controller 2 via the address control circuit 4. A configuration of the address control circuit 4 will be described below.

The address control circuit 4 receives the chip enable signal CEn, the command latch enable signal CLE, the address latch enable signal ALE, the write enable signal WEn, the pair of read enable signals RE and REn, and the write-protect signal WPn, which are the external control signals from the memory controller 2. The pair of read enable signals RE and REn is configured as a differential signal. Hereinafter, when the pair of read enable signals RE and REn is described, only the read enable signal REn will be mentioned and the read enable signal RE will not be mentioned. The address control circuit 4 transmits the received external control signals to the nonvolatile memory 3.

To transmit and receive each signal to and from the memory controller 2 via the address control circuit 4, the nonvolatile memory 3 includes a plurality of terminals (pads (not illustrated)) corresponding to the chip enable signal CEn, the command latch enable signal CLE, the address latch enable signal ALE, the write enable signal WEn, the read enable signal REn, and the write-protect signal WPn which are the external control signals, and a terminal (pad (not illustrated)) corresponding to the read/busy signal R/B.

To transmit and receive commands, addresses, and data to and from the memory controller 2, the address control circuit 4 transmits and receives the signals DQ<7:0> and the pair of data strobe signals DQS and DQSn. The pair of data strobe signals DQS and DQSn is configured as a differential signal. Hereinafter, when the pair of data strobe signals DQS and DQSn is described, only the data strobe signal DQS will be mentioned and the data strobe signal DQSn will not be mentioned. The address control circuit 4 receives commands, addresses, and data as an external input by the signals DQ<7:0> from the memory controller 2. The address control circuit 4 outputs data from the nonvolatile memory 3 as an external output to the memory controller 2. The data includes data necessary for an operation of the nonvolatile memory 3 in addition to data which is written in the memory cell array 36 and data which is read from the memory cell array 36.

To transmit and receive commands, addresses, and data to and from the memory controller 2 via the address control circuit 4, the nonvolatile memory 3 includes a plurality of terminals (pads (not illustrated)) corresponding to the signals DQ<7:0> and the data strobe signal DQS.

The signal CEn enables selection of the nonvolatile memory 3. The signal CLE enables latching of a command transmitted as a signal DQ, in the data input/output buffer 32 (or a command register (not illustrated)). The signal ALE enables latching of an address transmitted as the signal DQ, in the address register 33. The signal WEn enables writing of a command or an address in the data input/output buffer 32 or the address register 33. The signal REn enables reading of data from the data input/output buffer 32. The signal WPn inhibits execution of a write operation and an erase operation to the memory cell array 36. The ready/busy signal R/B indicates whether the nonvolatile memory 3 is in a ready state (a state in which a command can be received from the outside) or a busy state (a state in which a command cannot be received from the outside). The memory controller 2 can know a state of the nonvolatile memory 3 by receiving the ready/busy signal R/B.

The overall control circuit 31 receives an external control signal from the memory controller 2 via the address control circuit 4. The overall control circuit 31 transmits the ready/busy signal R/B as a status output to the memory controller 2 via the address control circuit 4. The overall control circuit 31 receives a command from the data input/output buffer 32, generates an internal control signal according to a sequence based on the command, and controls each unit of the nonvolatile memory 3.

The data input/output buffer 32 receives a command and data from the memory controller 2 via the address control circuit 4. The data input/output buffer 32 transfers the received command and data to the overall control circuit 31. The data input/output buffer 32 receives write data from the address control circuit 4 and transits the write data to the column control circuit 34. The data input/output buffer 32 receives data read from the memory cell array 36 from the column control circuit 34 and outputs the read data to the memory controller 2 via the address control circuit 4.

The address register 33 receives an address from the memory controller 2 via the address control circuit 4. The address register 33 also receives an address generated in the address control circuit 4. Batched output addresses to be described below are output from the address control circuit 4. Serial output addresses to be described below are output from the address control circuit 4 in some cases. The address register 33 supplies a row address to the row control circuit 35 and supplies a column address to the column control circuit 34, among the received addresses. The address register 33 is configured with, for example, an SRAM.

The row control circuit 35 receives the row address from the address register 33 and decodes the row address. The row control circuit 35 executes a select operation of each word line of the memory cell array 36 based on the decoded row address. The row control circuit 35 is supplied with a plurality of voltages necessary for a write operation, a read operation, and an erase operation from a voltage generation circuit (not illustrated). The row control circuit 35 transfers voltages necessary for operations to selected blocks and word lines.

The column control circuit 34 receives the column address from the address register 33 and decodes the column address. The column control circuit 34 is connected to each bit line of the memory cell array 36 and selects one bit line based on the decoded column address. The column control circuit 34 detects and amplifies data read from the memory cell transistor MT to the bit line during reading of data. The column control circuit 34 transfers the read data to the data input/output buffer 32 in series.

The column control circuit 34 transfers data transferred in series from the data input/output buffer 32 to the bit lines of the memory cell array 36 and writes the data in the memory cell transistors MT during writing of data.

### Address Control Circuit

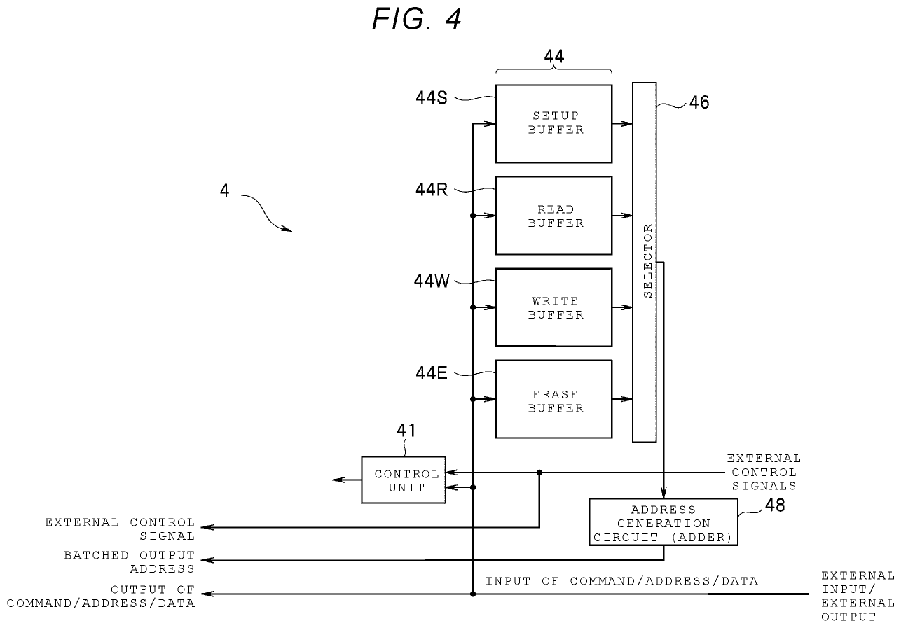

FIG. 4 is a block diagram illustrating an example of a specific configuration of the address control circuit 4.

The address control circuit 4 includes a control unit 41, an address buffer group 44, a selector 46, and an address generation circuit 48. The address buffer group 44 is generally referred to as a buffer. The address control circuit 4 includes a plurality of terminals (not illustrated) for receiving external control signals (for example, the chip enable signal CEn, the command latch enable signal CLE, the address latch enable signal ALE, the write enable signal WEn, the read enable signal REn, and the write-protect signal WPn) from the memory controller 2. The address control circuit 4 includes a plurality of terminals (not illustrated) for transmitting the external control signals to the overall control circuit 31. The address control circuit 4 outputs the external control signals received from the memory controller 2 to the overall control circuit 31 of the nonvolatile memory 3 as is and also supplies the external control signals to the control unit 41.

The control unit 41 generally controls the address control circuit 4. Functions of the control unit 41 may be implemented by dedicated hardware, a processor executing a program, or a combination thereof.

The address control circuit 4 includes a plurality of terminals (not illustrated) that transmit and receive the signals DQ<7:0> and the data strobe signal DQS for transferring commands, data, and addresses to and from the memory controller 2. The address control circuit 4 includes a plurality of terminals (not illustrated) that transmit and receive the signals DQ<7:0> and the data strobe signal DQS for transferring commands, data, and addresses to and from the data input/output buffer 32 and the address register 33 of the nonvolatile memory 3.

An external input (command/address/data) from the memory controller 2 is directly supplied to the nonvolatile memory 3 and is also supplied to the control unit 41 and the address buffer group 44.

The address buffer group 44 includes a setup buffer 44S, a read buffer 44R, a write buffer 44W, and an erase buffer 44E. The setup buffer 44S stores a setup address transferred in conjunction with a setup command from the memory controller 2. The setup command is also referred to as a sense command. The read buffer 44R stores a read address transferred in conjunction with a read command from the memory controller 2. The read command is also referred to as a data-out command. The write buffer 44W stores a write address transferred in conjunction with a write command from the memory controller 2. The erase buffer 44E stores an erase address transferred in conjunction with an erase command from the memory controller 2.

When a command and an address are input from the memory controller 2, the control unit 41 transfers the address to each buffer in the address buffer group 44 according to the type of command and stores the address therein. For example, when a read command and a read address corresponding to the read command are input from the memory controller 2 to the address control circuit 4, the control unit 41 stores the read address in the read buffer 44R.

The address stored in each of the buffers 44S, 44R, 44W, and 44E in the address buffer group 44 is supplied to the address generation circuit 48 via the selector 46. The selector 46 is controlled by the control unit 41. The selector 46 selects a buffer of the address buffer group 44 corresponding to a command, and outputs the address stored in the selected buffer to the address generation circuit 48. That is, the selector 46 selects and outputs the address stored in the setup buffer 44S, the read buffer 44R, the write buffer 44W, or the erase buffer 44E respectively in correspondence with a setup command, a read command, a write command, and an erase command.

The address generation circuit 48 is configured to newly generate addresses based on the input addresses. For example, the address generation circuit 48 may generate addresses for subsequent commands by increasing the addresses input in conjunction with the previous commands in sequential access. Here, the sequential access refers to an access in which ranges of addresses (physical addresses of the nonvolatile memory 3) designated with the same type of command in a plurality of commands are continuous. Here, the address generation circuit 48 may include an adder. The address generation circuit 48 may update the addresses stored in the corresponding buffers in the address buffer group 44 by addresses generated by adding. A method of generating subsequent addresses is not limited to an adding method. The address generation circuit 48 may generate subsequent addresses by adding or subtracting any constant integer to the previous addresses.

For example, when addresses for the sequential access are input from the memory controller 2, the address generation circuit 48 can generate addresses to be designated to the nonvolatile memory 3. Accordingly, here, the addresses to be supplied from the memory controller 2 to the nonvolatile memory 3 can be omitted. The address generation circuit 48 can transfer addresses of a plurality of bytes, which are transferred at a plurality of cycles in the IO bus, to the address register 33 of the nonvolatile memory 3 in one cycle of an internal clock of the address control circuit 4. For example, when a bit width of signal lines through which the signals DQ<7:0> in the IO bus are transferred is 8 bits, 5-byte addresses are output from the memory controller 2 in five cycles (that is, toggle of 5 times of the signal WEn). When a bit width of signal lines through which addresses are transferred between the address control circuit 4 and the nonvolatile memory 3 is 40 bits, the 5-byte addresses can be transferred to the nonvolatile memory 3 in one cycle of the internal clock. Hereinafter, addresses output as such from the address generation circuit 48 are referred to as batched output addresses. The internal clock of the address control circuit 4 may be generated in the nonvolatile memory 3 and supplied to the address control circuit 4. Alternatively, the internal clock of the address control circuit 4 may be generated in the memory controller 2 and supplied to the address control circuit 4 (and the nonvolatile memory 3).

Note that the address generation circuit 48 may serially output generated addresses of a plurality of bytes to the address register 33, for example byte by byte. The addresses output as such from the address generation circuit 48 are referred to as serial output addresses.

In the embodiment, during the sequential access, the memory controller 2 omits transfer of second and subsequent addresses to the IO bus and transmits an address operation command to generate addresses to the address control circuit 4. The memory controller 2 executes a normal sequence when accessing addresses that are discontinuous with the addresses previously accessed (i.e., when the access is not the sequential access).

The address generation circuit 48 may generate addresses to be supplied to the nonvolatile memory 3 by adding a predetermined offset value to addresses read from the address buffer. The offset value may be a negative value. For example, the offset value may be set in the address control circuit 4 by a set feature command or the like from the memory controller 2.

### Operation

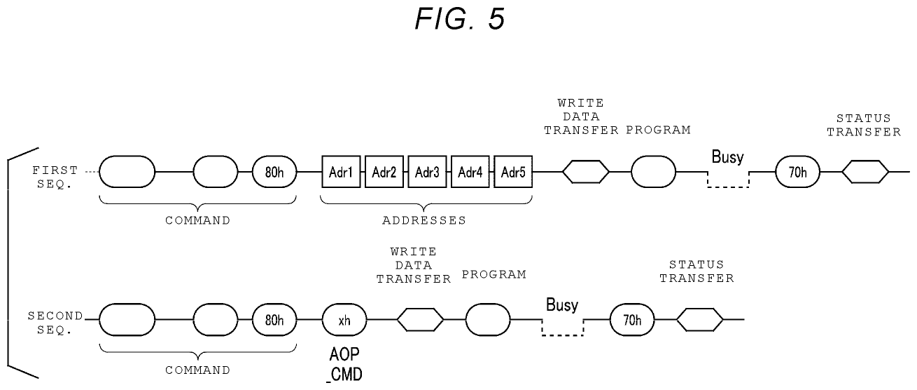

Next, an operation of the memory system 1 having such configuration according to the first embodiment will be described with reference to FIGS. 5 to 12. FIGS. 5 to 8 are sequence diagrams illustrating each operation sequence under the control of the memory controller 2. FIGS. 5 to 8 illustrate various signal states transmitted and received via the IO bus connecting the memory controller 2 and the address control circuit 4. Here, some of the signal states are not illustrated. In FIGS. 5 to 8, ellipses indicate various commands. Rectangles indicate addresses. Hexagons indicate transmission and reception of data to and from the memory controller 2. Commands to designate a write operation, a read operation, an erase operation, and the like to the nonvolatile memory 3 are configured with a command string including a command option.

FIG. 5 is a sequence diagram illustrating a write sequence under the control of the memory controller 2.

In the embodiment, the first sequence of the sequential access is different from the second and subsequent sequences. The first sequence is similar to a general sequence. That is, as illustrated in FIG. 5, in the first sequence of the write sequence, 5-byte write addresses Adr1 to Adr5 are transferred after a command group including a command indicated by 80h. After the write addresses Adr1 to Adr5, write data is transferred. The commands, the write data, and the addresses are transferred to the data input/output buffer 32 and the address register 33 of the nonvolatile memory 3 via the address control circuit 4. When a transfer period of the write data ends, a program command is transferred. Accordingly, the nonvolatile memory 3 executes a write operation (program operation). During the write operation, the nonvolatile memory 3 enters the busy state (a dotted line portion of FIG. 5). Subsequently, the memory controller 2 issues a status read command (70h). The nonvolatile memory 3 transfers a status to the memory controller 2 in response to the status read command.

In the first sequence, the address control circuit 4 supplies the external input to the nonvolatile memory 3 as is. The control unit 41 determines a type of command in the external input. The control unit 41 stores the addresses transferred after the command in a corresponding buffer of the address buffer group 44 according to the determined type of the command. In the example of FIG. 5, the control unit 41 determines that the input command is a write command and stores the write addresses Adr1 to Adr5 in the write buffer 44W.

Next, the second sequence of the write sequence illustrated in FIG. 5 is executed. The second sequence is different from the first sequence in that the memory controller 2 issues a 1-byte address operation command (xh), which is hereinafter referred to an AOP_CMD command, instead of the 5-byte addresses. When the AOP_CMD command is received, the control unit 41 determines a type of command received in the sequence before the reception of the AOP_CMD command. The control unit 41 controls the selector 46 based on the determined type and gives the addresses stored in the buffer corresponding to the determined type to the address generation circuit 48. That is, here, the addresses stored in the write buffer 44W are supplied to the address generation circuit 48. The address generation circuit 48 is controlled by the control unit 41 such that addresses continuous to the address Adr5 are sequentially generated by increasing the address Adr5. The addresses from the address generation circuit 48 may be supplied as batched output addresses to the nonvolatile memory 3. As such, in the second and subsequent sequences, addresses necessary for each sequence are supplied from the address control circuit 4 to the nonvolatile memory 3.

As such, in the write sequence according to the embodiment, the 1-byte AOP_CMD command is transferred instead of the 5-byte addresses in the second and subsequent sequence of the sequential access. Therefore, it is possible to reduce an overhead caused by the address transfer.

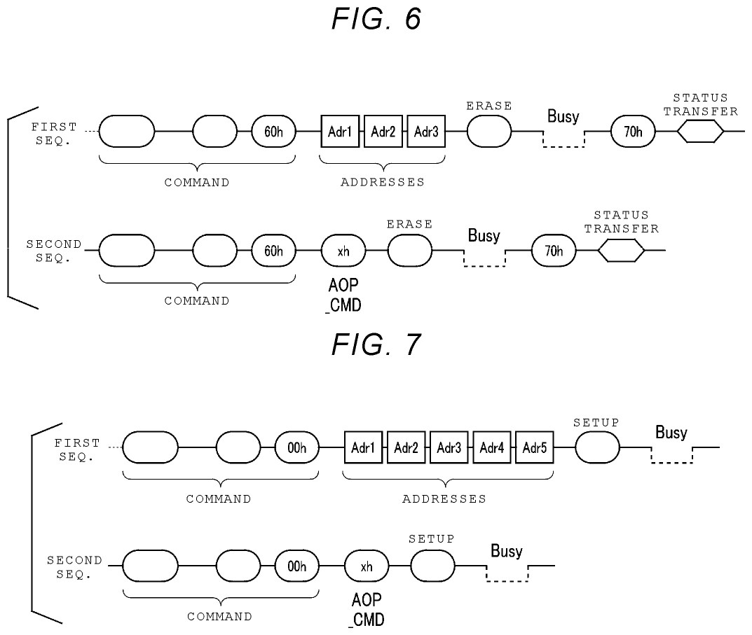

FIG. 6 is a sequence diagram illustrating an erase sequence under the control of the memory controller 2.

The first sequential access is similar to a general sequence. That is, as illustrated in FIG. 6, 3-byte erase addresses (block addresses) Adr1 to Adr3 are transferred after a command group including a command indicated by 60h in the first sequence of the erase sequence. Subsequently, an erase command is transferred. Accordingly, the nonvolatile memory 3 executes an erase operation for a block designated with the block address. During the erase operation, the nonvolatile memory 3 enters the busy state (a dotted line portion of FIG. 6). Subsequently, the memory controller 2 issues a status read command (70h). The nonvolatile memory 3 transfers a status to the memory controller 2 in response to the status read command.

As such, in the first sequence, the address control circuit 4 supplies the external input to the nonvolatile memory 3 as is. The control unit 41 determines a type of command in the external input in the first sequence and stores the addresses transferred after the command in a corresponding buffer of the address buffer group 44 according to the determined type of the command. In the example of FIG. 6, the control unit 41 determines that the input command is an erase command and stores the erase addresses Adr1 to Adr3 in the erase buffer 44E.

Similarly to the write sequence, the memory controller 2 issues the 1-byte AOP_CMD command instead of the addresses in the second and subsequent sequences of the sequential access. That is, in the example of FIG. 6, in the second sequence of the erase sequence, the memory controller 2 issues the 1-byte AOP_CMD command (xh) instead of the 3-byte addresses. In the second and subsequent sequences of the sequential access, when the AOP_CMD command is received, the control unit 41 of the address control circuit 4 determines a type of command in the sequence before the reception of the AOP_CMD command and gives the addresses stored in the buffer corresponding to the determined type to the address generation circuit 48. In the example of FIG. 6, the address Adr3 is given to the address generation circuit 48. Then, the address generation circuit 48 sequentially generates addresses continuous to the address Adr3 by increasing the address Adr3. The addresses from the address generation circuit 48 can be supplied as the batched output addresses to the nonvolatile memory 3. As such, in the second and subsequent sequences, addresses necessary for each sequence are supplied from the address control circuit 4 to the nonvolatile memory 3.

As such, in the erase sequence according to the embodiment, the 1-byte AOP_CMD command is transferred instead of the 3-byte block addresses in the second and subsequent sequences of the sequential access. Therefore, it is possible to reduce an overhead caused by the address transfer.

FIG. 7 is a sequence diagram illustrating a setup sequence under the control of the memory controller 2. A setup is a process of transferring data read from the memory cell array 36 to the data input/output buffer 32. By executing a read sequence after the setup, the read data temporarily stored in the data input/output buffer 32 is transferred to the memory controller 2.

As illustrated in FIG. 7, 5-byte setup addresses Adr1 to Adr5 are transferred after a command group including a command indicated by 00h in the first sequence of the setup sequence. Subsequently, a setup command is transferred. Accordingly, data is read from the memory cell array 36 of the nonvolatile memory 3 and the read data is transferred to the data input/output buffer 32. During the setup operation, the nonvolatile memory 3 enters the busy state (a dotted line portion of FIG. 7). The control unit 41 determines that the input command is the setup command and stores the setup addresses Adr1 to Adr5 in the setup buffer 44S.

Subsequently, in the second sequence of the setup sequence illustrated in FIG. 7, the memory controller 2 issues the 1-byte AOP_CMD command instead of the 5-byte addresses. When the AOP_CMD command is received, the control unit 41 determines that the command in the sequence before the reception of the AOP_CMD command is the setup command. The control unit 41 gives the addresses stored in the setup buffer 44S to the address generation circuit 48. The address generation circuit 48 is controlled by the control unit 41 such that addresses continuous to the address Adr5 are sequentially generated by increasing the address Adr5. The addresses from the address generation circuit 48 may be supplied as batched output addresses to the nonvolatile memory 3. As such, in the second and subsequent sequences, addresses necessary for each sequence are supplied from the address control circuit 4 to the nonvolatile memory 3.

As such, in the setup sequence according to the embodiment, the 1-byte AOP_CMD command is transferred instead of the 5-byte addresses in the second and subsequent sequences of the sequential access. Therefore, it is possible to reduce an overhead caused by the address transfer.

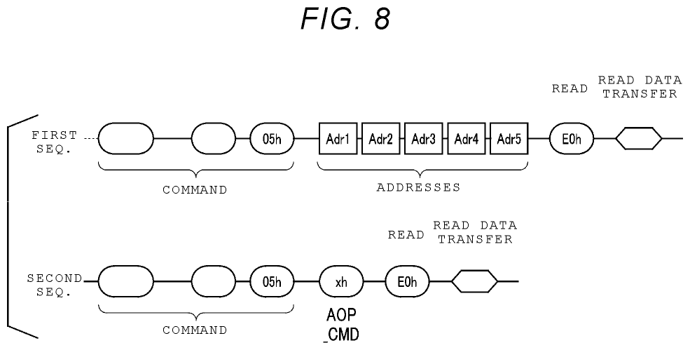

FIG. 8 is a sequence diagram illustrating a read sequence under the control of the memory controller 2.

As illustrated in FIG. 8, 5-byte read addresses Adr1 to Adr5 are transferred after a command group including a command indicated by 05h in the first sequence of the read sequence. Subsequently, a read command indicated by E0h is transferred. Accordingly, data temporarily stored in the data input/output buffer 32 is transferred to the memory controller 2.

In the first sequence, the address control circuit 4 supplies an external input to the nonvolatile memory 3 as it is. The control unit 41 stores the read addresses Adr1 to Adr5 transferred after the command in the corresponding read buffer 44R in the address buffer group 44 according to a determined type of the command.

Subsequently, in the second sequence of the read sequence illustrated in FIG. 8, the memory controller 2 issues the 1-byte AOP_CMD command instead of the 5-byte addresses. When the AOP_CMD command is received, the control unit 41 determines the read command in the sequence before the reception of the AOP_CMD command and gives the addresses stored in the read buffer 44R to the address generation circuit 48. The address generation circuit 48 is controlled by the control unit 41 such that addresses continuous to the address Adr5 are sequentially generated by increasing the address Adr5. The addresses from the address generation circuit 48 may be supplied as batched output addresses to the nonvolatile memory 3. As such, in the second and subsequent sequences, addresses necessary for each sequence are supplied from the address control circuit 4 to the nonvolatile memory 3.

As such, in the read sequence according to the embodiment, the 1-byte AOP_CMD command is transferred instead of the 5-byte addresses in the second and subsequent sequences of the sequential access. Therefore, it is possible to reduce an overhead caused by the address transfer.

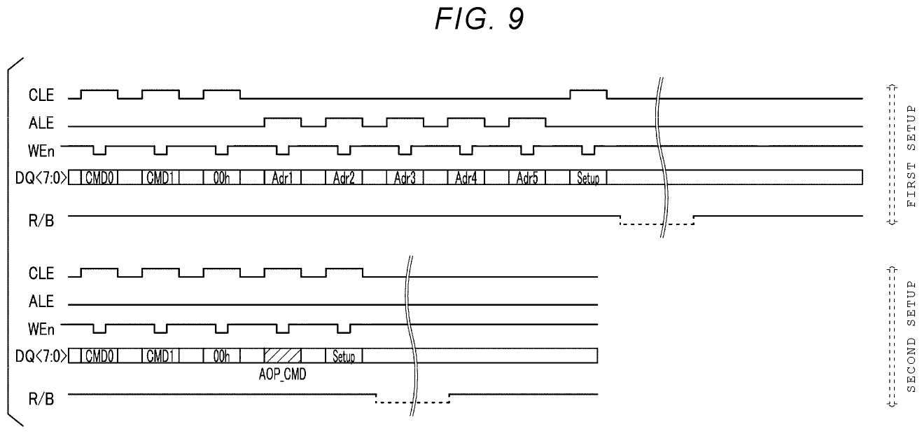

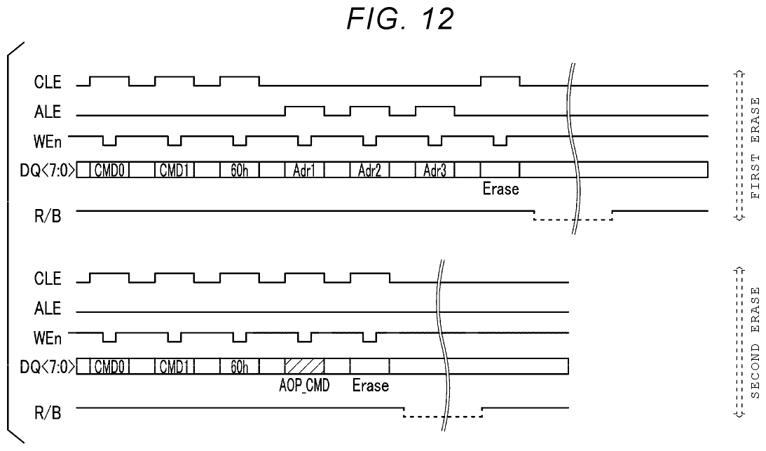

Next, details of various operation sequences under the control of the memory controller 2 will be described with reference to FIGS. 9 to 12. FIGS. 9 to 12 are timing charts illustrating the setup sequence, the read sequence, the write sequence, and the erase sequence, respectively. FIGS. 9 and 12 illustrate the command latch enable signal CLE, the address latch enable signal ALE, the write enable signal WEn, the signals DQ<7:0>, and the ready/busy signal R/B from the memory controller 2.

Commands and addresses are transferred as the signals DQ<7:0> in synchronization with the signal WEn. The control unit 41 receives the commands based on the asserted signal CLE. The control unit 41 receives the addresses based on the asserted signal ALE. In the example of FIG. 9, in the first sequence of the setup sequence, 5-byte setup addresses Adr1 to Adr5 are transferred after three commands of CMD0, CMD1, and 00h. A 1-byte setup command (Setup) is transferred after the transfer of the addresses. During the setup operation, the nonvolatile memory 3 enters the busy state (a dotted line portion of FIG. 9).

Subsequently, in the second sequence of the setup sequence illustrated in FIG. 9, the memory controller 2 transmits three commands similar to those of the first sequence by the signals CLE and WEn. The memory controller 2 transfers the 1-byte AOP_CMD command after the command group. The control unit 41 of the address control circuit 4 gives the addresses stored in the setup buffer 44S to the address generation circuit 48 according to the AOP_CMD command. The address generation circuit 48 is controlled by the control unit 41 such that addresses continuous to the address Adr5 are sequentially generated by increasing the address Adr5. For example, the 5-byte addresses may be supplied as batched output addresses from the address generation circuit 48 to the nonvolatile memory 3. The memory controller 2 transfers the 1-byte setup command (Setup). During the setup operation, the nonvolatile memory 3 enters the busy state (a dotted line portion of FIG. 9).

Even in the third and subsequent sequences, transfers similar to that of the second sequence are executed. In the setup sequence illustrated in FIG. 9, it is possible to reduce an overhead in the second and subsequent sequences of the sequential access.

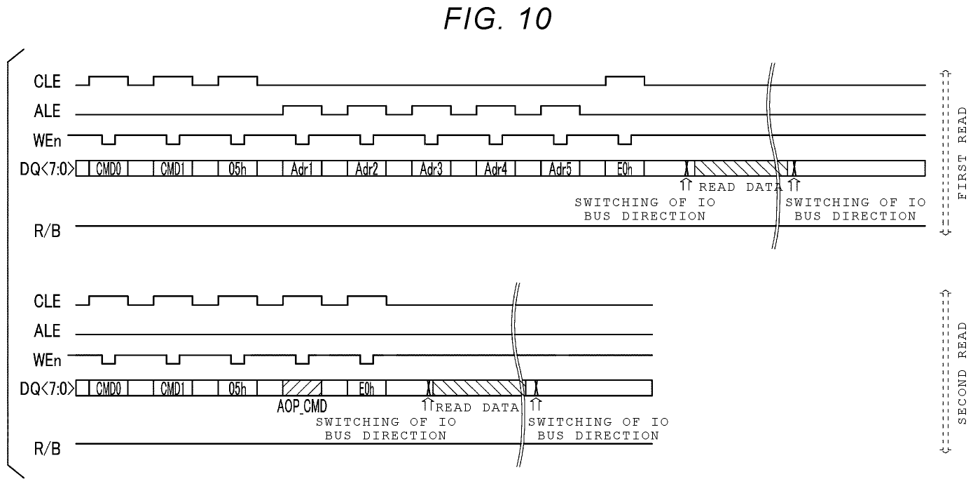

Even in the read sequence, transfer of the addresses are omitted in the second and subsequent sequences. As illustrated in FIG. 10, in the first sequence, the 5-byte read addresses Adr1 to Adr5 are transferred after three commands of CMD0, CMD1, and 05h. A 1-byte read command E0h is transferred after the transfer of the addresses. After the transfer of the read command E0h, a transfer direction of a signal line in the IO bus through which the signals DQ<7:0> are transferred is switched. That is, after the read command is transferred from the memory controller 2 to the nonvolatile memory 3 (the address control circuit 4), read data read from the nonvolatile memory 3 is transferred to the memory controller 2. After the transfer of the data, the transfer direction of the signal line is switched again.

Subsequently, in the second sequence of the read sequence illustrated in FIG. 10, the memory controller 2 transmits three commands similar to those of the first sequence. The memory controller 2 transfers the 1-byte AOP_CMD command after the command group. The control unit 41 of the address control circuit 4 gives the addresses stored in the read buffer 44R to the address generation circuit 48 according to the AOP_CMD command. The address generation circuit 48 is controlled by the control unit 41 such that addresses continuous to the address Adr5 are sequentially generated by increasing the address Adr5. For example, the 5-byte addresses may be supplied as batched output addresses from the address generation circuit 48 to the nonvolatile memory 3. The memory controller 2 transfers the 1-byte read command E0h. After the transfer of the read command E0h, the transfer direction of the signal line in the IO bus through which the signals DQ<7:0> are transferred is switched. After the read data read from the nonvolatile memory 3 is transferred to the memory controller 2, the transfer direction of the signal line is switched again.

Even in the third and subsequent sequences, transfers similar to that of the second sequence are executed. In the read sequence illustrated in FIG. 10, it is possible to reduce an overhead in the second and subsequent sequences of the sequential access.

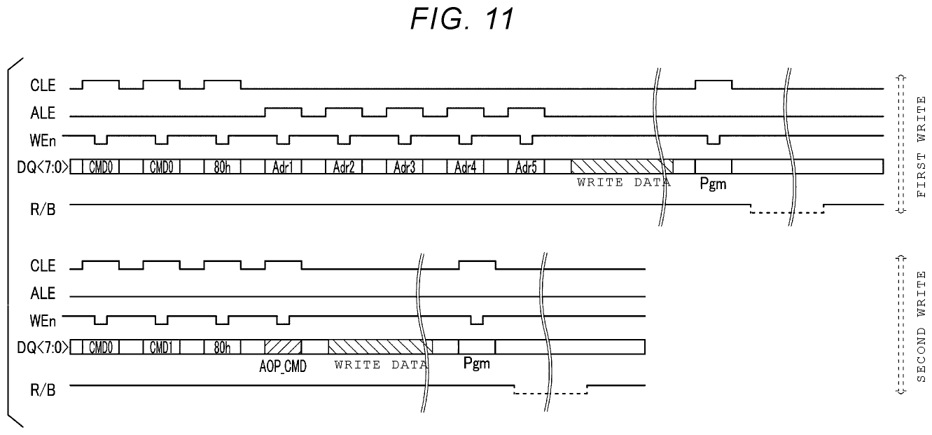

Even in the write sequence, transfer of the addresses are omitted in the second and subsequent sequences. As illustrated in FIG. 11, in the first sequence of the sequential access, the 5-byte read addresses Adr1 to Adr5 are transferred after three commands of CMD0, CMD1, and 80h. Subsequently, the memory controller 2 transfers write data. After the transfer of the write data, a 1-byte program command (Pgm) is transferred. During the program operation, the nonvolatile memory 3 enters the busy state (a dotted line portion of FIG. 11).

Subsequently, in the second sequence of the write sequence illustrated in FIG. 11, the memory controller 2 transmits three commands similar to those of the first sequence. The memory controller 2 transfers the 1-byte AOP_CMD command after the command group. The control unit 41 of the address control circuit 4 gives the addresses stored in the write buffer 44W to the address generation circuit 48 according to the AOP_CMD command. The address generation circuit 48 is controlled by the control unit 41 such that addresses continuous to the address Adr5 are sequentially generated by increasing the address Adr5. For example, the 5-byte addresses may be supplied as batched output addresses from the address generation circuit 48 to the nonvolatile memory 3. The memory controller 2 transfers the 1-byte program command (Pgm). During the program operation, the nonvolatile memory 3 enters the busy state (a dotted line portion of FIG. 11).

Even in the third and subsequent sequences, transfers similar to that of the second sequence are executed. In the write sequence illustrated in FIG. 11, it is possible to reduce an overhead in the second and subsequent sequences of the sequential access.

Even in the erase sequence, transfer of the addresses are omitted in the second and subsequent sequences. As illustrated in FIG. 12, in the first sequence of the sequential access, the 3-byte erase addresses Adr1 to Adr3 are transferred after three commands of CMD0, CMD1, and 60h. A 1-byte erase command (Erase) is transferred after the transfer of the addresses. During the erase operation, the nonvolatile memory 3 enters the busy state (a dotted line portion of FIG. 12).

Subsequently, in the second sequence of the erase sequence illustrated in FIG. 12, the memory controller 2 transmits three commands similar to those of the first sequence. The memory controller 2 transfers the 1-byte AOP_CMD command after the command group. The control unit 41 of the address control circuit 4 gives the addresses stored in the erase buffer 44E to the address generation circuit 48 according to the AOP_CMD command. The address generation circuit 48 is controlled by the control unit 41 such that addresses continuous to the address Adr3 are sequentially generated by increasing the address Adr3. For example, the 3-byte addresses may be supplied as batched output addresses from the address generation circuit 48 to the nonvolatile memory 3. The memory controller 2 transfers the 1-byte erase command (Erase). During the erase operation, the nonvolatile memory 3 enters the busy state (a dotted line portion of FIG. 12).

Even in the third and subsequent sequences, transfers similar to that of the second sequence are executed. In the erase sequence illustrated in FIG. 12, it is possible to reduce an overhead in the second and subsequent sequences of the sequential access.

As such, in the embodiment, the address control circuit that controls an input of the addresses to the nonvolatile memory is provided. For example, in the sequential access, the addresses generated by the address control circuit may be used instead of addresses input from the memory controller to the nonvolatile memory. Accordingly, it is possible to reduce an overhead in the transfer sequence.

### Modification

The example in which a single memory cell array 36 is in the nonvolatile memory 3 was described above. The embodiment may adopt a nonvolatile memory that has a multi-plane configuration including two or more planes.

In the multi-plane configuration, a plurality of memory cell arrays are located in the nonvolatile memory. In each memory cell array, a read operation, a write operation, and an erase operation can be executed independently in some cases.

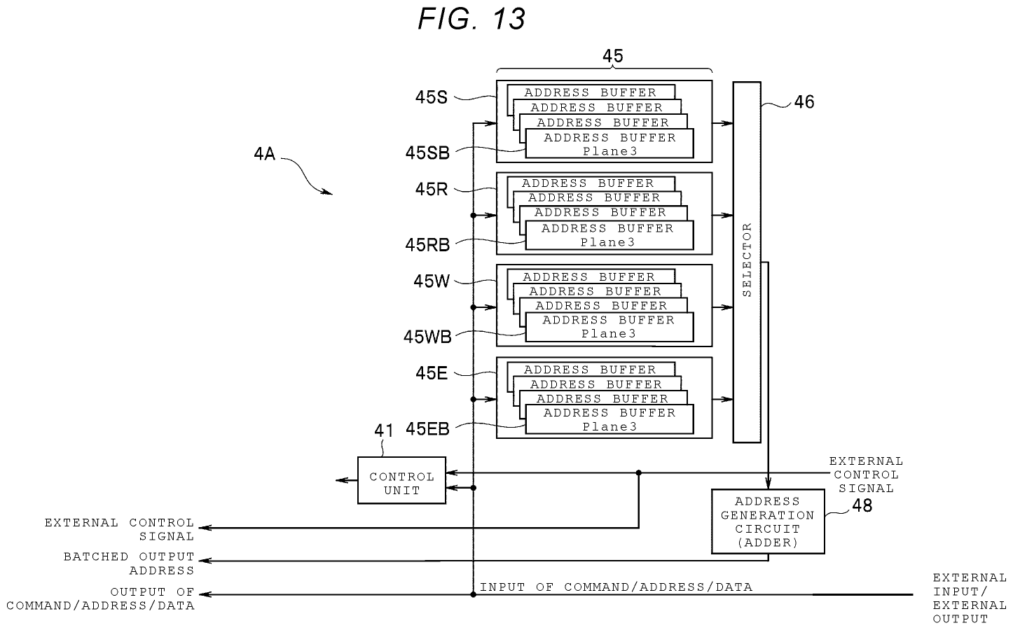

FIG. 13 is a block diagram illustrating an example of an address control circuit corresponding to a nonvolatile memory including a plurality of planes. In the modification, an address control circuit 4A is employed instead of the address control circuit 4.

The address control circuit 4A illustrated in FIG. 13 according to the modification is different form the address control circuit 4 illustrated in FIG. 4 according to the first embodiment in that an address buffer group 45 is employed instead of the address buffer group 44. The address buffer group 45 includes a setup buffer group 45S, a read buffer group 45R, a write buffer group 45W, and an erase buffer group 45E. The setup buffer group 45S includes a plurality of address buffers 45SB for respective planes. The read buffer group 45R includes a plurality of address buffers 45RB for respective planes. The write buffer group 45W includes a plurality of address buffers 45WB for respective planes. The erase buffer group 45E includes a plurality of address buffers 45EB for respective planes. Although an example of the address control circuit 4A in FIG. 13 illustrates a 4-plane configuration, the number of planes may be appropriately set.

Commands, addresses, and data for each plane are input to the address control circuit 4A. The control unit 41 selects an address buffer in the address buffer group 45 according to the input addresses corresponding to any command of any plane. In the modification, the address control circuit 4A may output batched output addresses for each plane.

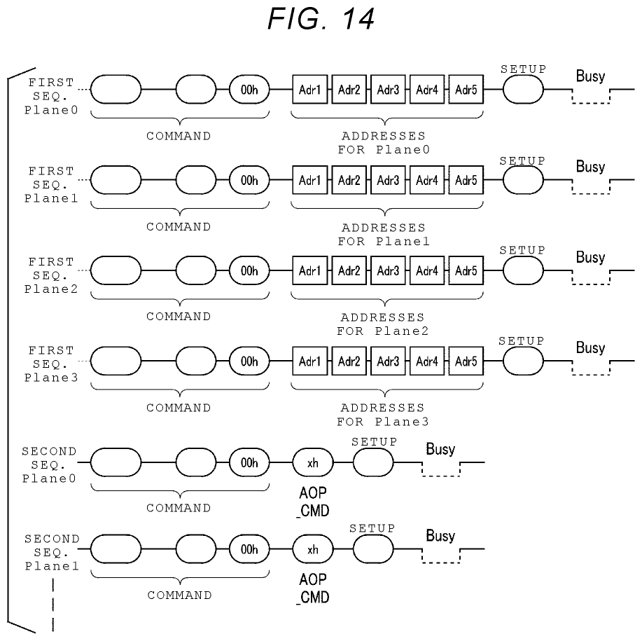

FIG. 14 is a sequence diagram illustrating an operation of the modification. FIG. 14 illustrates a setup sequence. In FIG. 14, the first stage indicates the first sequence for a 0th plane (Plane0), the second stage indicates the first sequence for a 1st plane (Plane1), the third stage indicates the first sequence for a 2nd plane (Plane2), and the fourth stage indicates the first sequence for a third plane (Plane3). The fifth and subsequent stages indicate the second and subsequent sequences for the 0th plane (Plane0) to 3rd plane (Plane3), respectively.

As illustrated in FIG. 14, in the first sequence of the setup sequence, 5-byte setup addresses Adr1 to Adr5 are transferred for each plane after a command group including a command indicated by 00h. Subsequently, a setup command for each plane is transferred. During a setup operation, each plane enters the busy state (a dotted line portion of FIG. 14).

The control unit 41 determines that the input command is a setup command and stores the setup addresses Adr1 to Adr5 in the setup buffer 44S. Here, the control unit 41 stores the setup addresses in the address buffer 45SB of a corresponding plane.

Subsequently, in the second sequence of the setup sequence illustrated in FIG. 14, the memory controller 2 issues a 1-byte AOP_CMD command instead of the 5-byte addresses. When the AOP_CMD command is received, the control unit 41 determines that the command in the sequence before the reception of the AOP_CMD command is the setup command. The control unit 41 gives the addresses stored in the address buffer 45SB of the corresponding plane of the setup buffer group 45S to the address generation circuit 48. The address generation circuit 48 is controlled by the control unit 41 such that addresses continuous to the address Adr5 are sequentially generated by increasing the address Adr5. The addresses from the address generation circuit 48 may be supplied as batched output addresses to the nonvolatile memory 3. When the second sequence is executed for all the planes, the third and subsequent sequences in each plane are sequentially executed. As such, in the second and subsequent sequences, addresses necessary for each sequence are supplied from the address control circuit 4A to the nonvolatile memory 3.

As such, in the setup sequence according to the modification, the 1-byte AOP_CMD command is transferred instead of the 5-byte addresses in the second and subsequent sequences of the sequential access. Therefore, it is possible to reduce an overhead caused by the address transfer. In the case of the 4-plane configuration illustrated in FIG. 14, it is necessary to transfer 20-byte addresses in the first sequence. Meanwhile, it is necessary to transfer only a 4-byte address operation command in the second and subsequent sequences, and thus the advantage of reducing the overhead is considerable.

In the foregoing description, only the addresses are changed to 1-byte address operation commands in the second and subsequent sequences and all the commands are transferred. However, a set of command and addresses may be converted into one address operation command. By substituting the set of command and addresses with a 1-byte address operation command, it is possible to further reduce an overhead.

### Advantages of Batched Output Addresses

In transfer via the IO bus used to transfer data between the memory controller 2 and the nonvolatile memory 3, acceleration of the transfer is relatively difficult due to limitation based on high-frequency characteristics or limitation based on switching of the data transfer direction, etc. Accordingly, in the embodiment, the addresses are transferred between the nonvolatile memory 3 and the address control circuit 4 capable of executing transfer at a relatively high transfer rate, and thus the transfer can be accelerated.

In the embodiment, the address control circuit 4 outputs the addresses collectively in the second and subsequent sequences of the sequential access, and thus the address transfer can be further accelerated.

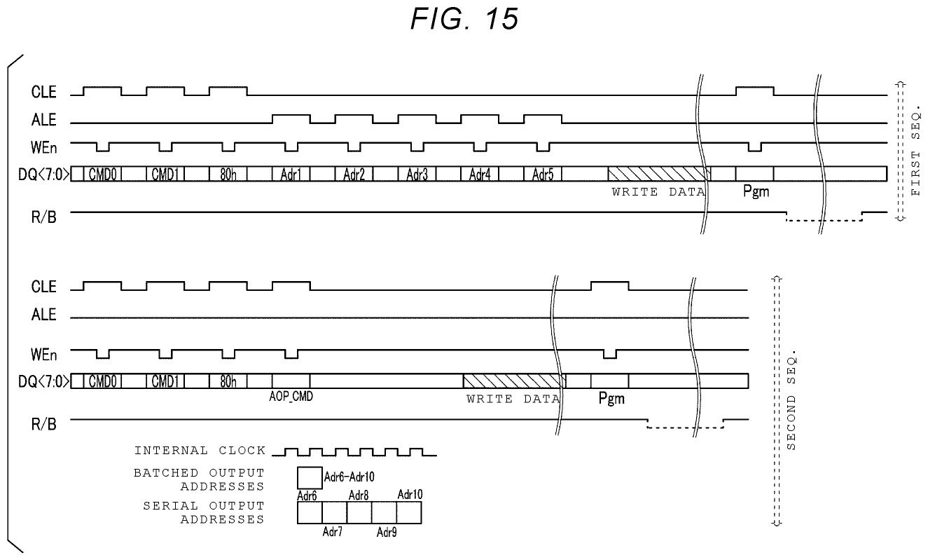

FIG. 15 is a timing chart illustrating acceleration by batched output addresses. FIG. 15 illustrates the command latch enable signal CLE, the address latch enable signal ALE, the write enable signal WEn, the signals DQ<7:0> from the memory controller 2, and the ready/busy signal R/B in the first sequence and the second and subsequent sequences of the write sequence. FIG. 15 further illustrates an output (batched output addresses and serial output addresses) of the address control circuit 4 in the second and subsequent sequences.

The commands and the addresses are transferred as the signals DQ<7:0> in synchronization with the signal WEn. The control unit 41 receives the commands based on the asserted signal CLE. The control unit 41 receives the addresses based on the asserted signal ALE. The control unit 41 stores the received addresses in the address buffer group 44 in synchronization with the signal WEn.

In the example of FIG. 15, in the first sequence of the sequential access, 5-byte setup addresses Adr1 to Adr5 are transferred after three commands of CMD0, CMD1, and 80h. After the transfer of the addresses, write data is transferred. Finally, the program command (Pgm) is transferred and the first sequence ends.

On the other hand, in the second sequence of the sequential access, the 1-byte AOP_CMD command is transferred after CMD0, CMD1, and 80h. The transfer of the 5-byte addresses from the memory controller 2 are omitted.

As illustrated in the lower part of FIG. 15, the address control circuit 4 operates according to an internal clock of the address control circuit 4, and 5-byte addresses Adr6 to Adr10 continuous to the address Adr5 generated by the address generation circuit 48 can be collectively transferred in one clock cycle of the internal clock of the address control circuit 4. Alternatively, the 5-byte addresses Adr6 to Adr10 may be transferred serially in five clock cycles of the internal clock of the address control circuit 4, one byte by one byte.

As illustrated in FIG. 15, the internal clock of the address control circuit 4 has a period shorter than a toggle period of the signal WEn. The address control circuit 4 can transfer the addresses faster than in the transfer using the IO bus in the case of either the batched output addresses or the serial output addresses because the addresses are transferred according to the internal clock. Accordingly, by omitting the address transfer from the memory controller 2 and transferring the addresses generated by the address control circuit 4 to the nonvolatile memory 3, it is possible to further accelerate the address transfer.

### Second Embodiment

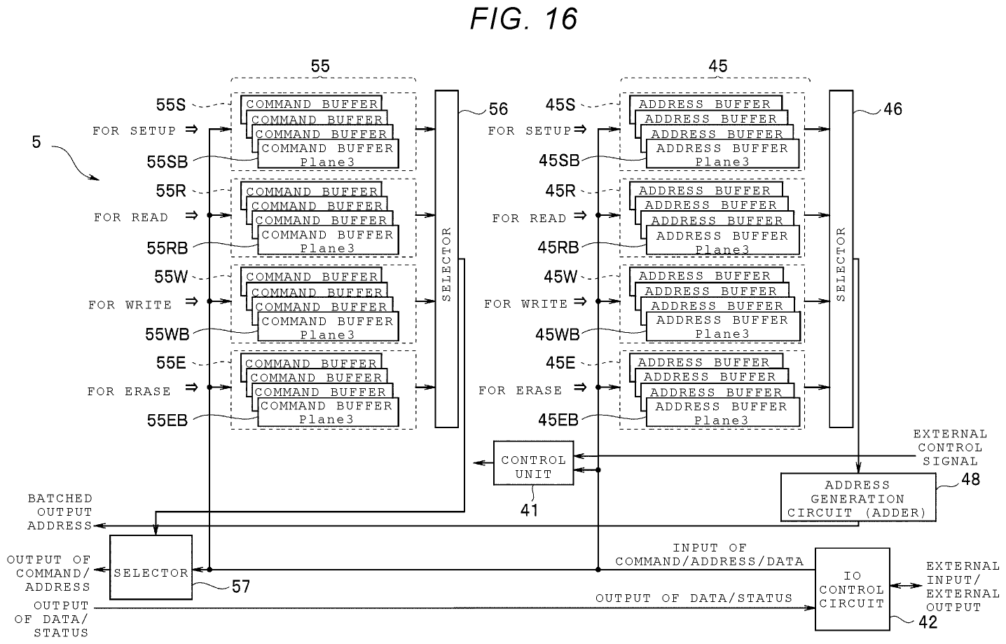

FIG. 16 is a block diagram illustrating a configuration of a command/address control circuit according to a second embodiment. In FIG. 16, the same reference numerals denote the same components as those of FIG. 4 or 13, and descriptions thereof will be omitted.

In the first embodiment, the example in which the address control circuit is provided and the address transfer from the memory controller 2 is omitted in the second and subsequent sequences of the sequential access was described. In the second embodiment, not only for addresses but also for commands, the transfer from the memory controller 2 can be omitted in the second and subsequent sequences of the sequential access. In the second embodiment, a command/address control circuit 5 is adopted instead of the address control circuit 4. The other configurations are similar to those of the first embodiment. In FIG. 16, a configuration corresponding to multi-planes is illustrated, but the command/address control circuit 5 may have a configuration corresponding to a single plane.

The command/address control circuit 5 includes the control unit 41, an IO control circuit 42, a command buffer group 55, the address buffer group 45, selectors 46, 56, and 57, and the address generation circuit 48. The command/address control circuit 5 is more generally referred to as a control circuit. The control unit 41 is an example of a second control circuit. The command buffer group 55 is an example of a second buffer. The command/address control circuit 5 includes a plurality of terminals (not illustrated) that receive external controls signals from the memory controller 2. The command/address control circuit 5 includes a plurality of terminals (not illustrated) that transmit external control signals to the overall control circuit 31. The command/address control circuit 5 outputs the external control signals received from the memory controller 2 to the overall control circuit 31 of the nonvolatile memory 3 as it is and also supplies the external control signals to the control unit 41.

The command/address control circuit 5 includes a plurality of terminals (not illustrated) that transmit and receive the signals DQ<7:0> and the data strobe signal DQS for transferring commands, data, and addresses to and from the memory controller 2. The command/address control circuit 5 includes a plurality of terminals (not illustrated) that transmit and receive the signals DQ<7:0> and the data strobe signal DQS for transferring commands, data, and addresses to and from the data input/output buffer 32 and the address register 33 of the nonvolatile memory 3.

An external input from the memory controller 2 is given to the IO control circuit 42. The IO control circuit 42 can transmit commands, addresses, and data, which are the external input, to the data input/output buffer 32 and the address register 33 of the nonvolatile memory 3. The IO control circuit 42 can also output commands, addresses, and data, which are the external input, to the selector 57. The IO control circuit 42 is controlled by the control unit 41 to determine whether to output the external input directly to the nonvolatile memory 3 or output the external input to the selector 57.

In the embodiment, the IO control circuit 42 also gives the external input to the control unit 41. The IO control circuit 42 gives the commands of the external input to the command buffer group 55. The IO control circuit 42 gives the addresses of the external input to the address buffer group 45. The IO control circuit 42 outputs data and a status input from the nonvolatile memory 3 as an external output to the memory controller 2.

The command buffer group 55 includes a setup buffer group 55S, a read buffer group 55R, a write buffer group 55W, and an erase buffer group 55E. The setup buffer group 55S, the read buffer group 55R, the write buffer group 55W, and the erase buffer group 55E each include a plurality of command buffers 55SB, 55RB, 55WB, and 55EB for storing a setup command, a read command, a write command, and an erase command for respective planes. The command/address control circuit 5 in FIG. 16 is an example corresponding to a 4-plane configuration, and the number of planes may be appropriately set.

When the commands and the addresses are output from the IO control circuit 42, the control unit 41 transfers and stores the commands in the command buffer according to the type of command, and transfers and stores the addresses corresponding to the command in the address buffer according to the type of command for each plane. For example, when the read command and the read addresses corresponding to the read command are output from the IO control circuit 42, the control unit 41 stores the read command in the command buffer 55RB in the read buffer group 55R, and stores the read addresses in the address buffer 45RB in the read buffer group 45R.

The command stored in each command buffer in the command buffer group 55 is supplied to the selector 57 via the selector 56. The selector 56 outputs a command stored in the command buffer designated by the control unit 41 to the selector 57. Addresses stored in each address buffer in the address buffer group 45 are supplied to the address generation circuit 48 via the selector 46.

The address generation circuit 48 newly generates addresses based on the input addresses. The selector 57 is controlled by the control unit 41 such that the commands and the addresses input from the selector 56 and the address generation circuit 48 are output in the same sequence as the original transfer sequence. The commands and the addresses from the selector 57 are supplied to the data input/output buffer 32 and the address register 33 of the nonvolatile memory 3, respectively.

In the embodiment, when a storage command re-execution instruction is received from the memory controller 2 in the second and subsequent sequences of the sequential access, the control unit 41 executes a storage command re-execution function of emulating a command sequence process of the memory controller 2. That is, when the storage command re-execution instruction is received, the control unit 41 sequentially outputs the commands and the addresses stored in the command buffer group 55 and the address buffer group 45 via the selectors 56 and 57 at timings according to the original interface specification.

In the embodiment, the memory controller 2 can give the storage command re-execution instruction to the command/address control circuit 5 using an external control signal. For example, since the addresses and the commands are not simultaneously transferred in normal data transfer, the signals CLE and ALE are not simultaneously asserted. In the embodiment, by using a combination of the external control signals, which are not generated in the normal data transfer, for the storage command re-execution instruction, it is possible to read the commands and the addresses in the second and subsequent sequences. That is, in the first sequence of the sequential access, the commands and the addresses are output from the memory controller 2 via the signal lines through which the signals DQ<7:0> are transferred. On the other hand, in the second sequence of the sequential access, the storage command re-execution instruction is output from the memory controller 2 via a signal line different from the signal lines through which the signals DQ<7:0> are transferred (for example, a signal line through which the signal CLE is transferred and a signal line through which the signal ALE is transferred).

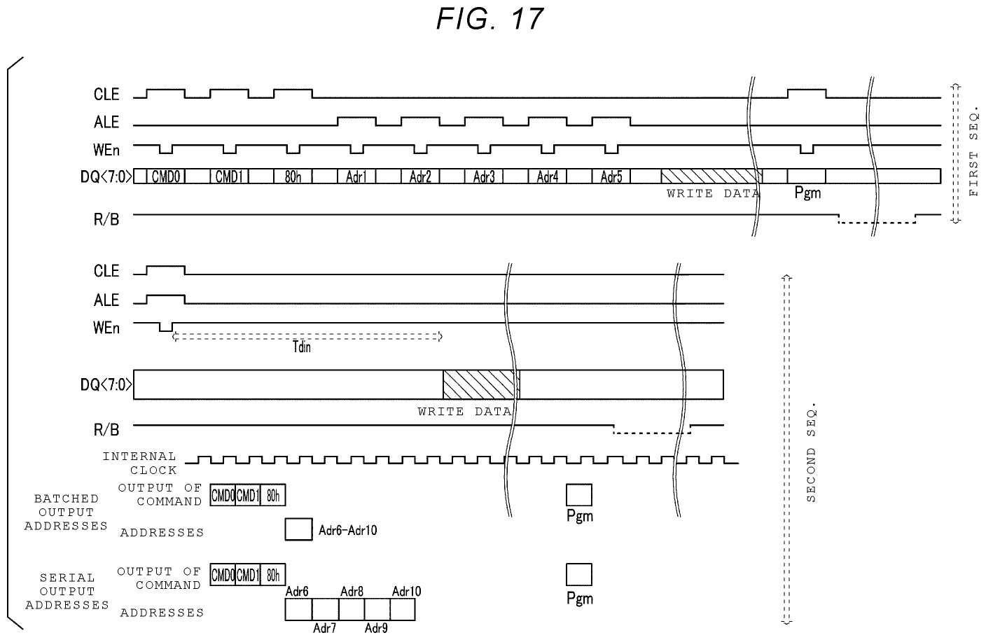

Next, an operation according to the second embodiment configured as described above will be described with reference to FIGS. 17 to 21. FIG. 17 is a timing chart illustrating an operation according to the second embodiment. In FIG. 17, each signal state between the memory controller 2 and the command/address control circuit 5 is illustrated in the first sequence and the second and subsequent sequences of the write sequence. In FIG. 17, an output from the command/address control circuit 5 to the nonvolatile memory 3 in the second and subsequent sequences is further illustrated. In FIG. 17, an example of a single plane is illustrated to facilitate description.

In the example of FIG. 17, the 5-byte addresses Adr1 to Adr5 are transferred after three commands CMD0, CMD1, and 80h in the first sequence of the sequential access. After the transfer of the addresses, write data is transferred. Finally, the program command (Pgm) is transferred and the first sequence ends.

The control unit 41 of the command/address control circuit 5 stores the commands input via the IO control circuit 42 in the command buffer of the command buffer group 55 according to the type of command. The control unit 41 stores the addresses input via the IO control circuit 42 in the address buffer of the address buffer group 45 according to the type of command.

In the embodiment, the memory controller 2 omits the transfer of the three commands CMD0, CMD1, and 80h, and the 5-byte addresses Adr1 to Adr5 in the second sequence of the sequential access. The memory controller 2 transmits signals for the storage command re-execution instruction for omitting the transfer of the commands and the addresses instead of the transfer of the commands and addresses for the second sequence. In the example of FIG. 17, the memory controller 2 gives the storage command re-execution instruction by simultaneously asserting the signals CLE, ALE, and WEn. The memory controller 2 transfers write data after a predetermined time Tdin elapses, in which a process by the command/address control circuit 5 is considered to finish, from the simultaneous assertion. The signals used for the storage command re-execution instruction are not limited to the signals CLE, ALE, and WEn.

When it is detected that the signals CLE, ALE, and WEn are simultaneously asserted, the control unit 41 causes the selector 56 to output the commands to the selector 57 from the command buffer storing the commands before the simultaneous assertion. The control unit 41 causes the selector 46 to output the addresses to the address generation circuit 48 from the address buffer storing the addresses before the simultaneous assertion.

The address generation circuit 48 can generate addresses necessary for the second sequence and output the addresses as batched output addresses to the nonvolatile memory 3. The selector 57 outputs commands corresponding to the batched output addresses from the address generation circuit 48, to the nonvolatile memory 3. That is, the control unit 41 emulates a command sequence process of the memory controller 2 by outputting the commands from the selector 57 according to an interface specification between the memory controller 2 and the nonvolatile memory 3. The control unit 41 causes the address generation circuit 48 to increase the addresses read from the address buffer at a timing at which the addresses are output in the command sequence and collectively outputs the addresses to the address register 33 of the nonvolatile memory 3 at one cycle, for example.

In the example of FIG. 17, the selector 57 outputs the three commands CMD0, CMD1, and 80h read from the command buffer group 55 in synchronization with the internal clock of the command/address control circuit 5. In a clock cycle of the internal clock subsequent to the transferring of the command 80h, the addresses Adr6 to Adr10 generated by the address generation circuit 48 are collectively transferred to the nonvolatile memory 3. Subsequently, the IO control circuit 42 supplies the write data from the memory controller 2 to the nonvolatile memory 3. When the transfer of the write data ends, the control unit 41 transfers the program command (Pgm) to the nonvolatile memory 3.

As apparent from FIG. 17, even after omitting the transfer of the commands and the addresses from the memory controller 2 and simultaneously asserting several external control signals in the second and subsequent sequences of the sequential access, it is still possible to operate the nonvolatile memory 3. Accordingly, the memory controller 2 can omit the output of the commands and the addresses in the second and subsequent sequences, and thus it is possible to reduce an overhead of the command sequence.

The command/address control circuit 5 can collectively output the addresses in one clock cycle of the internal clock, and it is possible to accelerate the transfer of the addresses. As illustrated in FIG. 17, even when the addresses are serially output, sufficient acceleration is possible.

### Advantages of Multi-Planes

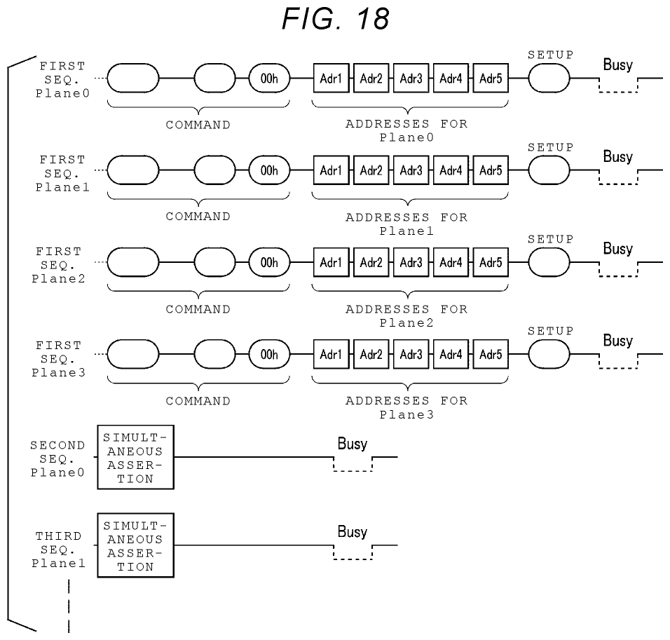

FIG. 18 is a sequence diagram illustrating a setup sequence in a multi-plane configuration.

In FIG. 18, the first stage indicates the first sequence for a 0th plane (Plane0), the second stage indicates the first sequence for a 1st plane (Plane1), the third stage indicates the first sequence for a 2nd plane (Plane2), and the fourth stage indicates the first sequence for a third plane (Plane3). The fifth and subsequent stages indicate the second and subsequent sequences for the 0th plane (Plane0) to 3rd plane (Plane3), respectively.

As illustrated in FIG. 18, in the first sequence of the setup sequence, 5-byte setup addresses Adr1 to Adr5 are transferred for each plane after a command group including a command indicated by 00h. Subsequently, a setup command for each plane is transferred. During a setup operation, each plane enters the busy state (a dotted line portion of FIG. 18).

In the second and subsequent setup sequences, the memory controller 2 omits the transfer of the commands and the addresses by simultaneously asserting several external control signals, as illustrated in FIG. 18. Accordingly, when it is assumed that 4-byte commands and 5-byte addresses are transferred to one plane in the first sequence, an amount of data corresponding to 36 cycles in the first sequence can be transferred in one cycle in the second and subsequent sequences.

### Advantages in Read Sequence

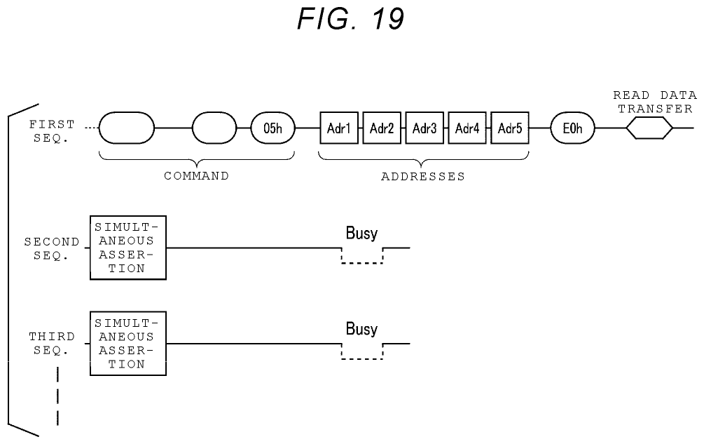

FIG. 19 is a sequence diagram illustrating a read sequence. As illustrated in FIG. 19, in the first sequence of the read sequence, 5-byte read addresses Adr1 to Adr5 are transferred after a command group including a command indicated by 05h. Subsequently, the read command E0h for transferring data temporarily stored in the data input/output buffer 32 to the memory controller 2 is transferred. Accordingly, the data from the nonvolatile memory 3 is transferred to the memory controller 2.

In the second and subsequent sequences of the read sequence, as illustrated in FIG. 19, the memory controller 2 omits the transfer of the commands and the addresses by simultaneously asserting several external control signals. Accordingly, in the read sequence, it is possible to reduce an overhead of the transfer sequence.

### Continuous Setup-and-Read Execution

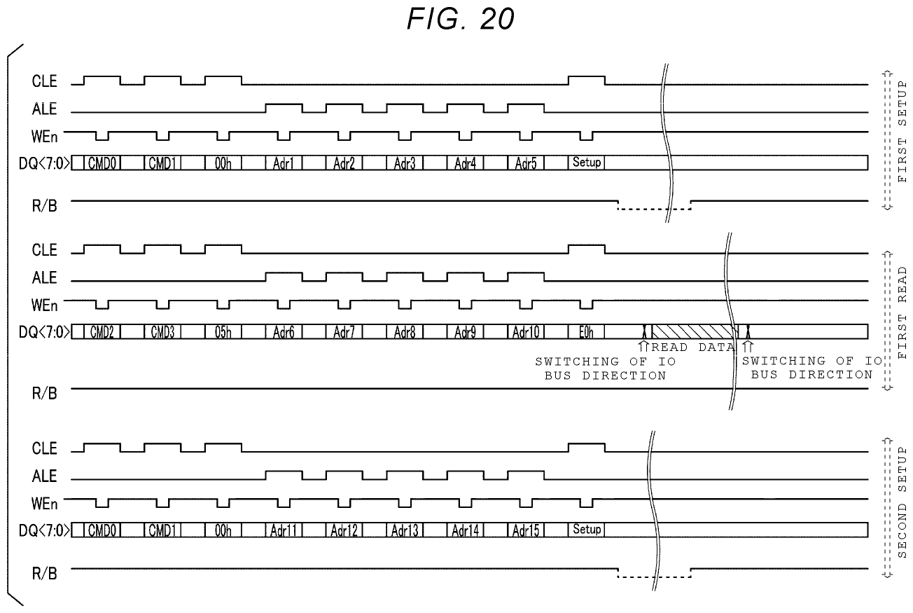

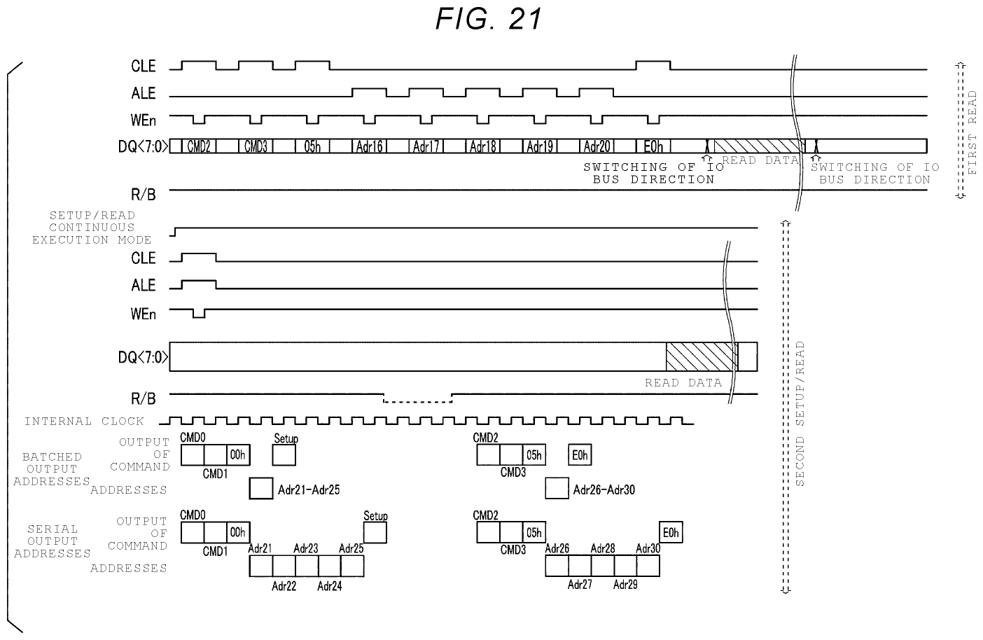

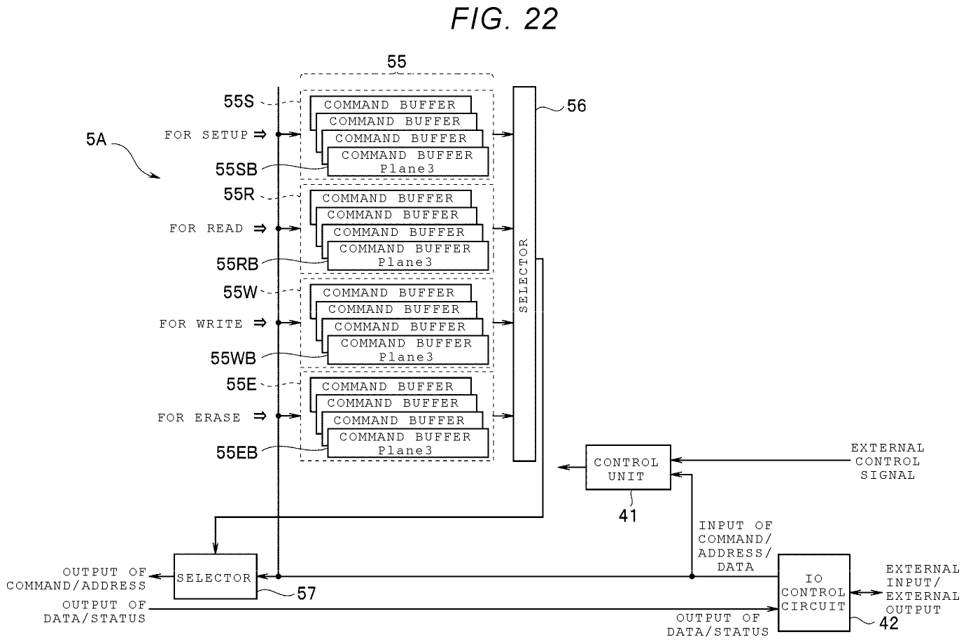

FIGS. 20 and 21 are timing charts illustrating a setup-and-read continuous execution sequence. FIGS. 20 and 21 illustrate each signal state between the memory controller 2 and the command/address control circuit 5. In FIG. 21, an output from the command/address control circuit 5 to the nonvolatile memory 3 is also illustrated. FIG. 20 illustrates a sequence according to a comparative example and FIG. 21 illustrates a sequence according to the second embodiment.

In the example of FIG. 21, the nonvolatile memory 3 is set to a setup/read continuous mode, and setup and read are continuously executed by simultaneously asserting the signals CLE, ALE, and WEn in the second and subsequent sequences. The mode setting can be executed with, for example, a command or the like from the memory controller 2 or setting of a register (not illustrated) in the nonvolatile memory 3.

In the sequential access in which the setup and the read are continuously executed, the first sequence of the setup sequence is first executed, and then the first sequence of the read sequence is executed. Subsequently, the second sequence of the setup sequence is executed, and then the second sequence of the read sequence is executed. Also in the third and subsequent sequences, the setup sequence is first executed, and then the read sequence is executed.

In FIG. 20, the first sequence of the setup sequence is illustrated in the upper part, the first sequence of the read sequence is illustrated in the middle part, and the second sequence of the setup sequence is illustrated in the lower part. In FIG. 20, sequences after the second read sequence are omitted.

In the first sequence of the setup sequence, the signals CLE and WEn are first asserted and the commands CMD0, CMD1, and 00h are transferred. Subsequently, the signals ALE and WEn are asserted and the addresses Adr1 to Adr5 are transferred. Subsequently, the signals CLE and WEn are asserted and a setup command is transferred. During the setup operation, the nonvolatile memory 3 enters the busy state (a dotted line portion of FIG. 20).

In the first sequence of the subsequent read sequence, the signals CLE and WEn are first asserted and commands CMD2, CMD3, and 05h are transferred. Subsequently, the signals ALE and WEn are asserted and the addresses Adr6 to Adr10 are transferred to the IO bus. Subsequently, the signals CLE and WEn are asserted and the read command E0h is transferred. As a result, read data read from the memory cell array 36 is transferred from the command/address control circuit 5 to the memory controller 2.

Before and after the transfer of the read data, it is necessary to switch a data transfer direction in the IO bus. As such, in the read sequence, it is necessary to switch a transfer direction of the IO bus twice, and thus acceleration of the data transfer is obstructed.

In the comparative example, the second and subsequent setup sequences and read sequences are similar to the first setup sequence and read sequence.

In the embodiment, however, the second and subsequent setup sequences and read sequences are different from the first setup sequence and read sequence.

In FIG. 21, the first read sequence is illustrated in the upper part and the second and subsequent setup/read sequences are illustrated in the lower part. In the embodiment, the first setup sequence and read sequence are similar to the first setup sequence and read sequence illustrated in the upper and middle parts of FIG. 20 according to the comparative example. In the embodiment, in continuous execution of the setup sequence and the read sequence of the sequential access, the second and subsequent sequences are sequentially executed without transferring the commands and the addresses from the memory controller 2.

That is, in the second and subsequent setup/read sequences, the signals CLE, ALE, and WEn are first simultaneously asserted.

When it is detected that the signals CLE, ALE, and WEn are simultaneously asserted, the control unit 41 causes the selector 56 to output the commands from the command buffer storing the commands before the simultaneous assertion to the selector 57. The control unit 41 causes the selector 46 to output the addresses from the address buffer storing the addresses before the simultaneous assertion to the address generation circuit 48.

The address generation circuit 48 generates addresses necessary for the second setup sequence and outputs the generated addresses as batched output addresses to the nonvolatile memory 3. The selector 57 outputs a command corresponding to the batched output addresses from the address generation circuit 48, to the nonvolatile memory 3. That is, as illustrated in FIG. 21, the selector 57 outputs the commands CMD0, CMD1, and 00h read from the command buffer group 55 in synchronization with the internal clock of the command/address control circuit 5. In a clock cycle of the internal clock after the command 00h is transferred, addresses Adr21 to Adr25 generated in the address generation circuit 48 are collectively transferred to the nonvolatile memory 3. In a clock cycle of the internal clock after the batched output addresses are transferred, a setup command is output to the nonvolatile memory 3. During the setup operation, the nonvolatile memory 3 enters the busy state (a dotted line portion of FIG. 21).

When the setup operation ends, the address generation circuit 48 generates addresses necessary for the second read sequence and outputs the generated addresses as batched output addresses to the nonvolatile memory 3. The selector 57 outputs a command corresponding to the batched output addresses from the address generation circuit 48, to the nonvolatile memory 3. That is, as illustrated in FIG. 21, the selector 57 outputs the commands CMD2, CMD3, and 05h read from the command buffer group 55 in synchronization with the internal clock of the command/address control circuit 5. In a clock cycle of the internal clock after the command 05h is transferred, addresses Adr26 to Adr30 generated in the address generation circuit 48 are collectively transferred to the nonvolatile memory 3. The command/address control circuit 5 outputs the command E0h to the nonvolatile memory 3 in a clock cycle of the internal clock after the batched output addresses are transferred. In response to the command, the read data read from the nonvolatile memory 3 is transferred to the memory controller 2.

When the command/address control circuit 5 outputs serial output addresses, as illustrated in FIG. 21, transfer of subsequent commands (Setup) and (E0h) is delayed while 5-byte serial output addresses are output, compared to the case of the batched output addresses.

As apparent from FIG. 21, in the embodiment, the memory controller 2 can omit the transfer of the commands and the addresses in the second and subsequent sequences, and it is not necessary to switch the transfer direction of the IO bus in the second and subsequent sequences. In the second and subsequent sequences, the commands and the addresses are transferred in synchronization with the internal clock of the command/address control circuit 5, and thus data transfer can be accelerated. The command/address control circuit 5 can collectively output the addresses, and thus further acceleration can be achieved.

As such, in the embodiment, when the storage command re-execution instruction is received, the command/address control circuit 5 generates the increased addresses, sequentially retransmits the commands stored in the command buffer group 55 according to the original interface specification, and emulates a command sequence process of the memory controller 2. Accordingly, in the second and subsequent sequences of the sequential access, the transfer of the commands and the addresses from the memory controller 2 can be omitted, and thus it is possible to reduce an overhead of the transfer sequence. Since the commands and the addresses can be transferred using a high-speed internal clock of the command/address control circuit 5, the transfer can be accelerated. In particular, in the read sequence, it is possible to reduce an overhead of the change in the data transfer direction of the IO bus. The addresses can be collectively output, and thus the transfer can be further accelerated.

### Third Embodiment

FIG. 22 is a block diagram illustrating a configuration of a command control circuit according to a third embodiment. In FIG. 22, the same reference numerals denote the same components as those of FIG. 16, and descriptions thereof will be omitted.

In the second embodiment, the example in which the transfer of the commands and the addresses from the memory controller 2 is omitted in the second and subsequent sequences of the sequential access by providing the command/address control circuit 5 was described. In the third embodiment, transfer of various commands from the memory controller 2 to the nonvolatile memory 3, for example, transfer of commands from the memory controller 2 in the second and subsequent sequences of the sequential access, can be omitted. In the third embodiment, a command control circuit 5A is adopted instead of the command/address control circuit 5. Other configurations are similar to those of the second embodiment. FIG. 22 illustrates a configuration corresponding to multi-planes, but the command control circuit 5A may have a configuration corresponding to a single plane.

The command control circuit 5A is configured by omitting the address buffer group 45, the selector 46, and the address generation circuit 48 from the command/address control circuit 5 illustrated in FIG. 16. That is, in the command control circuit 5A, the function of generating and outputting the addresses is omitted from the command/address control circuit 5. The command control circuit 5A is another example of the first control circuit.

In the embodiment, the IO control circuit 42 gives a command in the external input to the command buffer group 55. When a command is output from the IO control circuit 42, the control unit 41 transfers and stores the command in the command buffer according to the type of command for each plane. For example, when a read command is output from the IO control circuit 42, the control unit 41 stores the read command in the command buffer 55RB of the read buffer group 55R.

When the storage command re-execution instruction is received from the memory controller 2 in the second and subsequent sequences of the sequential access, the control unit 41 executes a storage command re-execution function of emulating a command sequence process of the memory controller 2. That is, when the storage command re-execution instruction is received, the control unit 41 sequentially outputs the commands stored in the command buffer group 55 via the selectors 56 and 57 at timings according to the original interface specification.

In the embodiment, the memory controller 2 can give the storage command re-execution instruction to the command control circuit 5A using an external control signal.

In the foregoing configuration of the embodiment, when the storage command re-execution instruction is received from the memory controller 2, the command control circuit 5A sequentially retransmits the commands stored in the command buffer group 55 according to the original interface specification. That is, the command control circuit 5A emulates the command sequence process of the memory controller 2. Accordingly, in the second and subsequent sequences of the sequential access, the transfer of the commands from the memory controller 2 can be omitted, and thus it is possible to reduce an overhead of the transfer sequence.

As such, according to the embodiment, it is possible to reduce the overhead of the transfer sequence by omitting the transfer of the commands.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a nonvolatile memory;
a memory controller; and
a control circuit including a buffer and configured to store a first address transmitted by the memory controller in the buffer, generate a second address based on the first address stored in the buffer, and transmit the generated second address to the nonvolatile memory.

2. The memory system according to claim 1, wherein the second address is an address that is continuous to the first address in a physical address space of the nonvolatile memory.

3. The memory system according to claim 1, wherein the control circuit generates the second address when locations of the nonvolatile memory are being sequentially accessed.

4. The memory system according to claim 1, wherein the control circuit generates the second address by adding or subtracting an integer value to or from the first address.

5. The memory system according to claim 1, wherein the control circuit generates the second address in response to a command supplied from the memory controller.

6. The memory system according to claim 1, wherein the buffer includes a plurality of buffer regions corresponding to different types of accesses to the nonvolatile memory, and the control circuit stores the first address in one of the buffer regions corresponding to the type of access being made to the nonvolatile memory in connection with the transmission of the first address by the memory controller.

7. The memory system according to claim 1, wherein the buffer includes a plurality of buffer regions corresponding to different planes of the nonvolatile memory, and the control circuit stores the first address in one of the buffer regions corresponding to the plane of the nonvolatile memory that is being accessed in connection with the transmission of the first address by the memory controller.

8. The memory system according to claim 1, wherein
the memory controller transmits the first address to the control circuit in a first number of clock cycles using a signal line having a first bit width, and
the control circuit transmits the second address to the nonvolatile memory in a second number of clock cycles, the second number being smaller than the first number, using a signal line having a second bit width that is greater than the first bit width.

9. The memory system according to claim 1, wherein the buffer includes a first buffer region in which the first address is stored and a second buffer region in which a command transmitted by the memory controller is stored, and the control circuit is configured to transmit the command stored in the second buffer region along with the second address to the nonvolatile memory.

10. The memory system according to claim 9, wherein
the memory controller transmits the first address to the control circuit using a first signal line, and
the control circuit transmits the command stored in the second buffer region along with the second address to the nonvolatile memory based on an external control signal that is transmitted from the memory controller to the control circuit using a second signal line different from the first signal line.

11. The memory system according to claim 1, wherein the nonvolatile memory and the control circuit are included in one package.

12. A memory system comprising:
a nonvolatile memory;
a memory controller; and
a control circuit including a buffer and configured to store a command transmitted by the memory controller at a first timing and transmit the command stored in the buffer to the nonvolatile memory in response to an instruction which is transmitted from the memory controller at a second timing different from the first timing.

13. The memory system according to claim 12, wherein the control circuit
stores a plurality of commands in the buffer, and
transmits the plurality of commands stored in the buffer to the nonvolatile memory in the same order as they were stored in the buffer.

14. The memory system according to claim 13, wherein
the buffer includes a first buffer region in which a first address transmitted by the memory controller is stored, and a second buffer region in which the plurality of commands transmitted by the memory controller are stored, and
the control circuit is configured to generate a second address based on the first address stored in the first buffer region, and transmit the generated second address to the nonvolatile memory after transmitting the plurality of commands stored in the second buffer region to the nonvolatile memory.

15. The memory system according to claim 12, wherein
the memory controller transmits the command to the control circuit using a first signal line, and
the control circuit transmits the command stored in the buffer to the nonvolatile memory in response to an instruction that is transmitted from the memory controller to the control circuit using a second signal line different from the first signal line.

16. The memory system according to claim 12, wherein the nonvolatile memory and the control circuit are included in one package.

17. A method of processing a sequence of commands issued by a memory controller, the commands in the sequence including a first command followed by a second command, said method comprising:
storing in a buffer a first address that is transmitted by the memory controller and associated with the first command;
generating a second address based on the first address stored in the buffer; and
transmitting the first command and the first address to a nonvolatile memory for execution of the first command by the nonvolatile memory, and then transmitting the second command and the second address to the nonvolatile memory for execution of the second command by the nonvolatile memory.

18. The method according to claim 17, wherein the buffer includes a plurality of buffer regions corresponding to different types of accesses to the nonvolatile memory, and the first address is stored in one of the buffer regions corresponding to the type of access being made to the nonvolatile memory when the first command is executed by the nonvolatile memory.

19. The method according to claim 17, wherein the buffer includes a plurality of buffer regions corresponding to different planes of the nonvolatile memory, and the first address is stored in one of the buffer regions corresponding to the plane of the nonvolatile memory that is being accessed when the first command is executed by the nonvolatile memory.

20. The method according to claim 17, wherein
the memory controller transmits the first address for storage in the buffer in a first number of clock cycles using a signal line having a first bit width, and
the second address is transmitted to the nonvolatile memory in a second number of clock cycles, the second number being smaller than the first number, using a signal line having a second bit width that is greater than the first bit width.
